(19) United States
(12) Patent Application Publication
(10) Pub. No.: US 2010/0007607 A1
(43) Pub. Date: Jan. 14, 2010

(54) Telescopic sliding mouse

(76) Inventor: Weigao Li, Shenzhen City (CN)

Correspondence Address: DAVID AND RAYMOND PATENT FIRM, 108 N. YNEZ AVE., SUITE 128, MONTEREY PARK, CA, 91754, US

(21) Appl. No.: 12/387,907

(22) Filed: May 7, 2009

(30) Foreign Application Priority Data
Jul. 11, 2008 (CN) 200820095478.7

(51) Int. Cl. G06F 3/033

(52) U.S. Cl. 345/163

(57) ABSTRACT

A telescopic sliding mouse, specifically, designed keeping in mind the users' hand size and regular using habits with adjustable length through a simple push-pull function in line with ergonomic principles. And the mouse has automatic space limit function when it adjusts to a suitable length. The telescopic sliding mouse includes a mouse body, a hand-rest sliding on its back and a slide device which is set up between the mouse body and the hand-rest. The slide device includes a relatively translational and elastic upper and lower slide plate fixed to the hand-rest and mouse body respectively. It is not only easy to use but also easy to store and is portable and fully human-oriented. The invention concerns the easy operation and convenience promoting comfort and hand rest feeling. Moreover, it is in accordance with ergonomic principles, with creative construction, delicate and rational structural design and implement easily.

### BACKGROUND OF THE PRESENT INVENTION

1. Field of Invention

The invention is a telescopic sliding mouse with adjustable functions. Specifically, the length of the mouse can be adjusted by a simple push-pull operation which according to the users' hand size and their using habits. And the mouse has automatic space limit function when it adjusts to a suitable length. The telescopic sliding mouse is not only easy to use, store and carry but also fully people-oriented.

2. Description of Related Arts

Most of mouse on the existing market has been welcomed by consumers for its easy to use, reliability and maturity of the technology. But the users have different individual requirements because different users have different palm sizes and different using habits. Take the length of the mouse for example. When the structure of the mouse is relatively shorter, it provides the advantage of being carried, packed and stored easily. But it will feel relatively difficult to operate and also proved to be quite uncomfortable. When the structure of the mouse is relatively longer, it will be easy to operate but it impact of carry, transport, packaging and storage convenience. Therefore the most important thing is that the existing structure of mouse does not have the property of adjusting its length according to the users' requirements

Although there are some telescopic mice with adjustable length in the existing technology, they all have the following shortcomings: The relative activities of components generate an abrasion due to friction between the linkages. This affects the consistency and performance of the telescopic mouse. This abrasion also limits the possibility of expansion, and accelerates the aging of materials, besides, it also deforms the moving parts. This leads to an overall effect while it's in use and leads to the overall efficiency being decreased. To quote an example lets consider when the elastic is adjusted, the stuck tight situation occurs, and therefore every time its efficiency has to be improved to be able to produce a better result. Since the working life also has to be extended, it leads to prove the fact that the existing mouse needs to be further improved and innovated.

### SUMMARY OF THE PRESENT INVENTION

The purpose of this invention is to solve the technical difficulty of providing a type of telescopic sliding mouse. This telescopic sliding mouse has been invented to live up to each user's individual requirements, having as one of its main features the ability to adjust its length according to the needs of everyone. This feature will not only increase the operational comfort but also give the touch at ease feeling. It also includes the elastic limit function during the process of expansion, which will increase the efficiency, leading to produce a better overall result and extension of the working life.

The technicalities of this invention are implemented as stated below: The structure of the telescopic sliding mouse includes a mouse body with a hand-rest sliding on its back and a slide device which is set between the mouse body and hand-rest. The slide device includes a relatively translational and elastic upper and lower slide plate fixed to the hand-rest and the mouse body respectively. Moreover, the upper and lower slide plate can be adjusted accordingly with hand-rest and mouse body. They can also be directly placed as the base plate of the hand-rest and the cover plate of the mouse body respectively.

It is preferred to set a table board to fix the upper slide plate onto the back surface of the hand-rest with screws, and combine with a convex plate for space limit. It means that, a convex plate for limiting upper slide plate is set under the back surface of the table board, correspondingly, a space-limit opening matching with the convex plate is set at the arbitrary end of the upper slide plate. Certainly, other fixation methods can also be used, such as paste and so on. Preferably, in the mouse body there is an embedding slot on its back, where the lower slide plate is fixed by screws, and a convex plate for limiting the lower slide plate is set at the arbitrary end or both ends of the embedding slot, correspondingly, a space-limit opening is set at the arbitrary end or both ends of the lower slide plate. The upper slide plate and the lower slide plate mutually limit and match each other in sliding motion. The two sides of the upper slide plate are twisted downwards like a crimping groove which a linear slide groove preferably to be made of plastic goes through, and two ends of the slide groove are protruded for space limit at two ends of the crimping groove. The two sides of the lower slide plate are curled upwards like an outward linear slide rail.

The slide device also contains two stacked interactive flakes rotationally fixed to the upper and lower slide plate respectively. It is preferably to be made of cold punched hardware, with the features of abrasion resistance, hard texture and high toughness, leading to an overall increased service life. This set of flakes are vertically inter-engaged and symmetrically matched. Besides this, there are also spring connections between them, enabling elastic interaction. Each stacked interactive flake contains a supporting and a rotational end. Both supporting ends are set with locating holes and corresponding rivets, and fixed to the upper and lower slide plate respectively. Spring hangers with springs are set at both sides of each rotational end. The springs used are tension springs, distributed symmetrically on both sides of the staked interactive flakes. Moreover, corresponding inter-engaged locking jaw and slot are set to the stacked interactive flakes respectively, and they are matched through sliding and space limit.

The upper slide plate can be directly placed as the back plate of hand-rest, while the lower slide plate can be directly placed as the cover plate of mouse body. The springs are set between the back plate of hand-rest and the cover plate of mouse body. Pressure and torsion spring can be used for practice, and both ends of the springs are fixed to the back plate and the cover plate respectively. Guiding slide rail and corresponding guiding linear chute are set on both sides of the back plate of hand-rest and both sides of the corresponding cover plate of mouse body. The guiding slide rail is not limited to be set on both sides of the back plate or cover plate, and the guiding linear chute is not limited to be set correspondingly on both sides of the back plate or cover plate, neither. Moreover, roller or roll ball and corresponding guiding linear chutes can also be set on both sides of the back plate of hand-rest and both sides of the cover plate of mouse body. It is preferred to set roller or roll ball on both sides of the back plate of hand-rest and set corresponding guiding linear chutes on both sides of the cover plate of mouse body. Furthermore, configured guiding pipes can also be set on both sides of the back plate of hand-rest and both sides of the corresponding cover plate of mouse body. It is preferred to set the outer pipe on both sides of the cover plate of mouse body and set the inner pipe on both sides of the back plate of hand-rest.

Features of the telescopic sliding mouse are as follows: telescopic function, structure with variable length, automatic space limit in extending or contracting accordingly, easy operation and application convenience, satisfying users' requirements of different mouse lengths, providing more comfort while its use, easy to carry, hand-rest function, in accordance with ergonomic principles, creative construction, delicate and rational structure, implement easily, and people oriented.

These and other objectives, features, and advantages of the present invention will become apparent from the following detailed description, the accompanying drawings, and the appended claims.

### BRIEF DESCRIPTION OF THE DRAWINGS

FIG. 1 is the breakdown structure diagram of the partial embodiment of the telescopic sliding mouse.

FIG. 2A is the structure diagram of embodiment of hand-rest stretching on the mouse body.

FIG. 2B is the partial breakdown structure diagram of the embodiment in FIG. 2A.

FIG. 2C is the breakdown structure diagram of the embodiment of the slide device in FIG. 2A.

FIG. 3A is the structure diagram of embodiment of hand-rest pushed back on the mouse body.

FIG. 3B is the partial breakdown structure diagram of embodiment in FIG. 3A.

FIG. 3C is the partial breakdown structure diagram of embodiment of the slide device in FIG. 3A.

FIG. 4 is the partial breakdown structure diagram of embodiment of the stacked interactive flakes.

FIG. 5 is the structure diagram of embodiment of the stacked interactive flakes combining with springs.

FIG. 6 is the breakdown structure diagram of embodiment of the back plate of hand-rest and the cover plate of mouse body with their two sides set with the matching guiding slide rails and guiding linear chutes.

FIG. 7 is the breakdown structure diagram of embodiment of the back plate of hand-rest and the cover plate of mouse body with their two sides set with matching rollers and guiding linear slide chutes.

FIG. 8 is the breakdown structure diagram of embodiment of the hand-rest's back plate and the mouse body's cover plate with their two sides set with matching guiding pipes.

### DETAILED DESCRIPTION OF THE PREFERRED EMBODIMENT

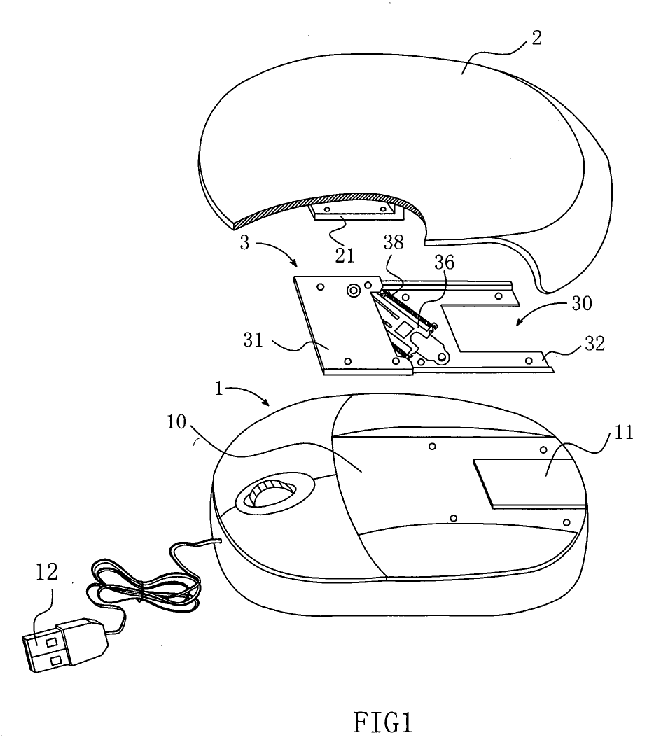

The telescopic sliding mouse shown in FIG. 1 includes mouse body I with a hand-rest 2 sliding on its back. It also shows a slide device 3 which is set between the mouse body 1 and the hand-rest 2, including a relatively translational and elastic upper slide plate 31 and lower slide plate 32 fixed to the hand-rest 2 and mouse body 1 respectively. It means that the upper slide plate 31 is fixed under the hand-rest 2, and the lower slide plate 32 is screwed onto the mouse body 1.

The embedding slot 10 for fixing the lower slide plate 32 is set on the back of the mouse body 1, and a convex plate 11 for space limit to the lower slide plate 32 is set up at one end of the embedding slot 10. Moreover, a space-limit opening 30 is set at one end of the lower slide plate 32 to match with the convex plate 11. When used, the function of space limit to the slide device 3 will be achieved, and also the screw holes are set on the lower slide plate 32 and the embedding slot 10 correspondingly and screws are used for fixation so that the coordination of the mouse body 1 and hand-rest 2 is more stable and closer. Correspondingly, the table board 21 for fixing the upper slide plate 31 is set under the hand-rest 2. It is preferred to set corresponding screw holes on the upper slide plate 31 and the table board 21 of hand-rest 2 and fix by screws, shown in FIG. 1. Certainly, the convex plate for space limit used for positioning the upper slide plate can be set onto the lower surface of the table board of hand-rest as well, and the space-limit opening is set at the corresponding end of the upper slide plate to match with the convex plate in the specific implementation.

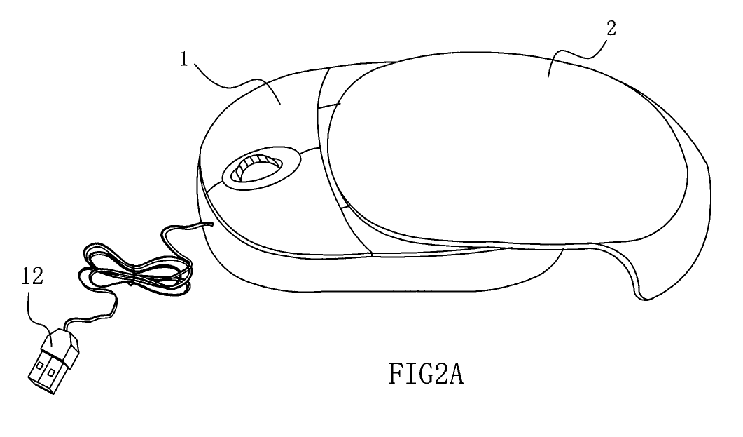

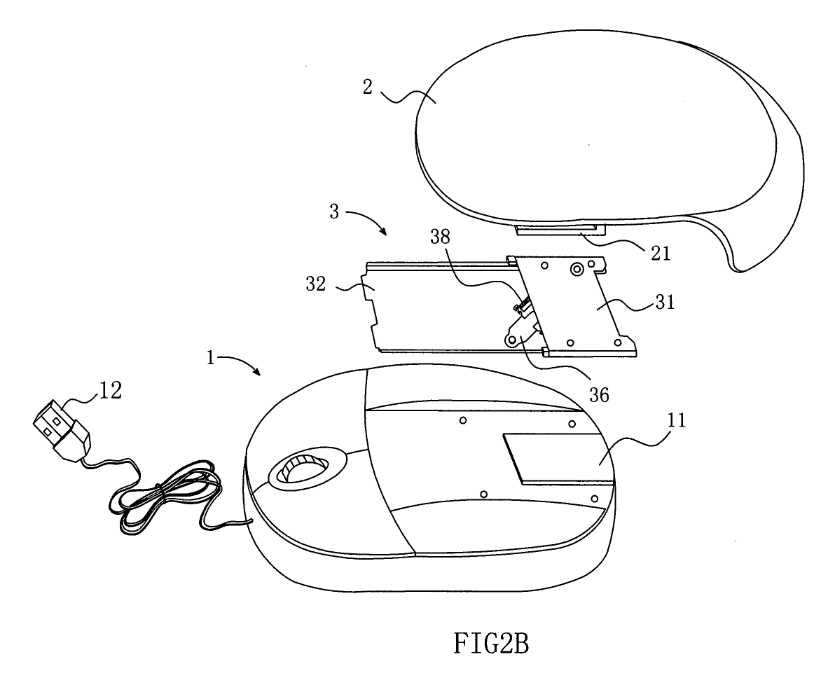

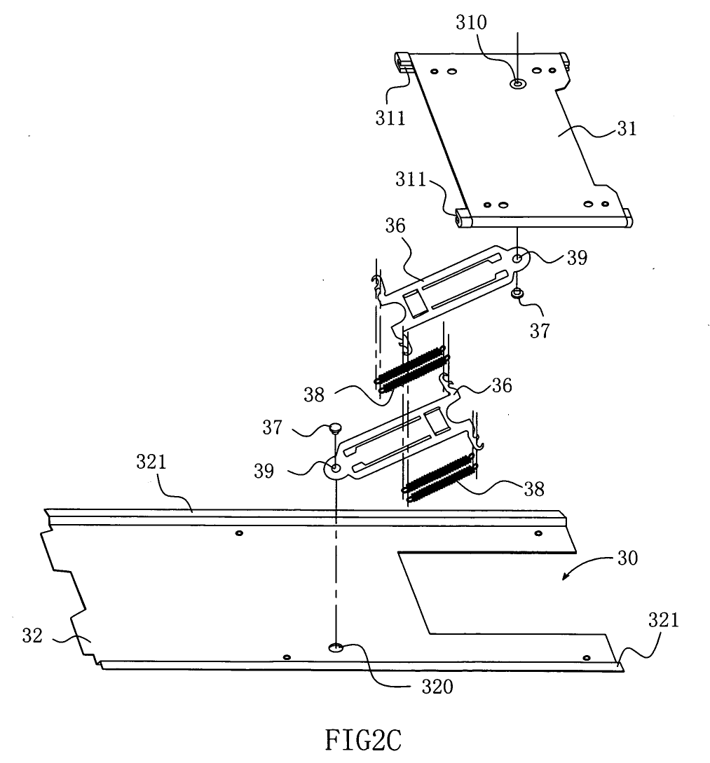

FIGS. 2A, 2B and 2C represent the preferred embodiment of hand-rest stretched on the mouse body.

As shown in FIG. 2A, when the hand-rest 2 is stretched on the mouse body 1, the length of the mouse body 1 is extended, meaning that, the hand-rest 2 is an active body capable of sliding back and forth on the mouse body 1, so as to achieve the telescopic adjustment to the mouse. Moreover, hand-rest 2 has certain tolerance when stretched out to withstand the wrist of human body, thus it is in line with the principles of ergonomics, moreover, it enhances the touch feeling in its use as a palm rest does.

As shown in FIG. 2B, the upper slide plate 31 is fixed under the hand-rest 2 and the lower slide plate 32 on the mouse body 1. When the hand-rest 2 is stretched on the mouse body 1, the upper slide plate 31 following the hand-rest 2 will slide to an end of the lower slide plate 32, that is, back-end of the mouse body 1, and the lower slide plate 32 is held still on the mouse body 1. The stacked interactive flakes 36 and the spring 34 connecting the flakes are also deflected to the corresponding end of the lower slide plate 32, and then the hand-rest 2 shows an elastic space limit on the mouse body 1.

As shown in FIG. 2C, two sides of upper slide plate 31 turn downwards as a crimping groove which the linear slide groove 311 goes through. Two ends of the linear slide groove 311 are protruded for space limit at two ends of the crimping groove. Two sides of the lower slide plate 32 are curled upwards like an outward linear slide rail 321. When the upper slide plate 31 slides to one end of the lower slide plate 32, the stacked interactive flakes 36 mutually engaged and connected by spring 38 are rotated at an angle along the fulcrum point 320 through the poisoning hole 39 of the lower slide plate 32 and the corresponding rivet 37. Correspondingly, the stacked interactive flakes 36 fixed to the upper slide plate 31 are rotated at the same angle along the fulcrum point 310 to achieve the elastic translation of the upper slide plate 31, that is, the relative elastic sliding between the hand-rest 2 and mouse body 1 is achieved by slide device 3, so that the extension of the mouse is achieved.

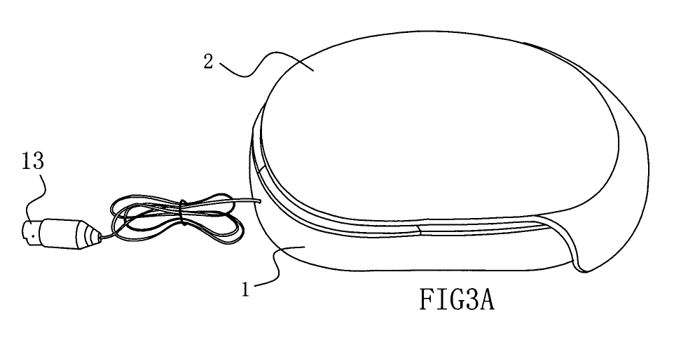

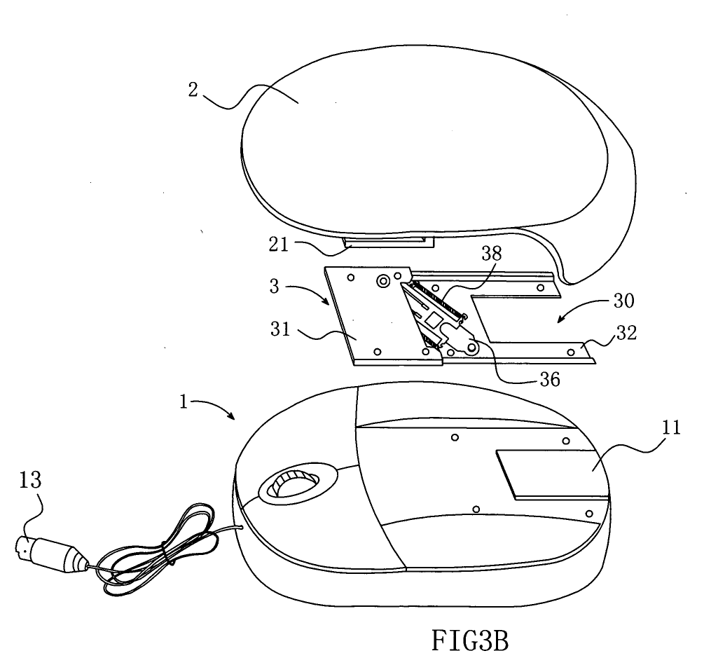

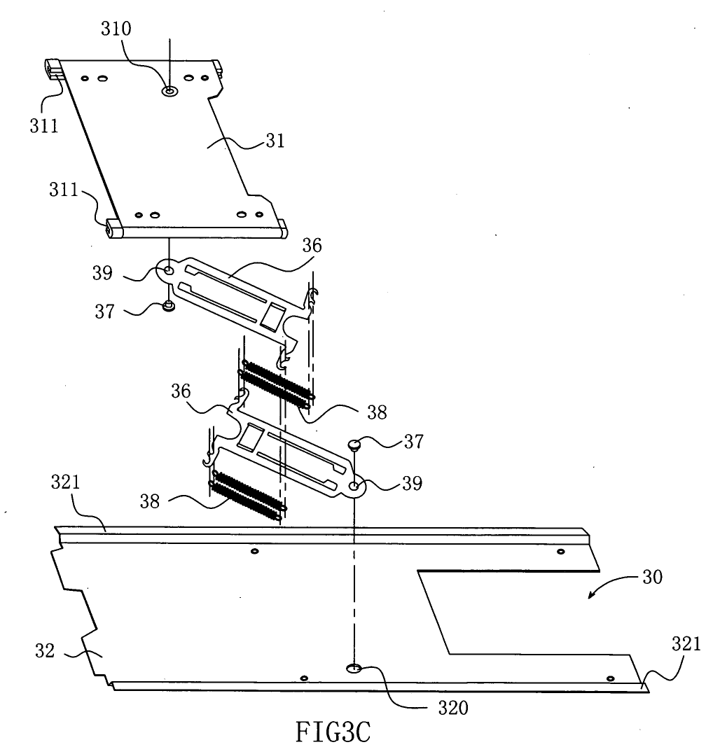

FIGS. 3A, 3B and 3C present the preferred embodiment of hand-rest pushed back on the mouse body.

As shown in FIG. 3A, the hand-rest 2 is pushed back on and overlapped with the mouse body 1, which relatively reduces the total size of the mouse and makes it easy to be carried, packed, transported and stored. Moreover, the hand-rest 2 covering the mouse body 1 is dust proof.

As shown in FIG. 3B, when the hand-rest 2 is pushed back on and overlapped with the mouse body 1, the upper slide plate 31 following the hand-rest 2 will elastically slide to an end of the lower slide plate 32 which is fixed on the mouse body 1, and the stacked interactive flakes 36 and the spring 34 connecting the flakes also deflect to the end of the lower slide plate 32 accordingly, and then the hand-rest 2 shows a elastic space limit to the mouse body 1 in contracting state.

As shown in FIG. 3C, when the upper slide plate 31 slides to one end of the lower slide plate 32, the stacked interactive flakes 36 mutually engaged and connected by spring 38 are rotated at an angle along the fulcrum point 320 through the poisoning hole 39 of the lower slide plate 32 and the corresponding rivet 37. Correspondingly, the stacked interactive flakes 36 fixed to the upper slide plate 31 are rotated at the same angle along the fulcrum point 310 to achieve the elastic return of the upper slide plate 31, meanwhile, the relative elastic sliding between the hand-rest 2 and mouse body 1 is achieved by slide device 3, thus the contraction of the mouse is achieved.

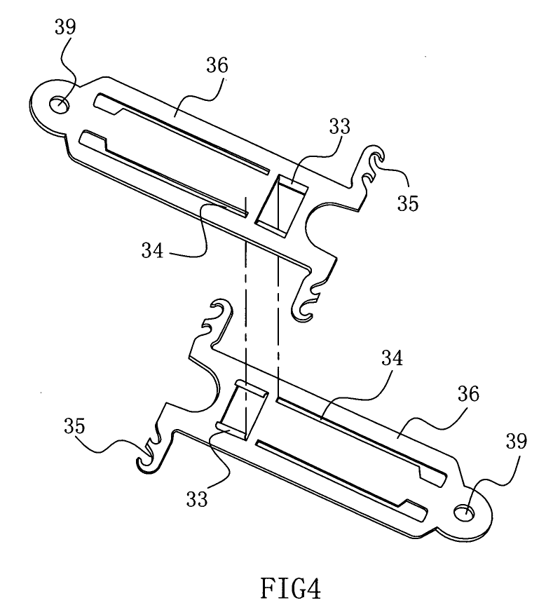

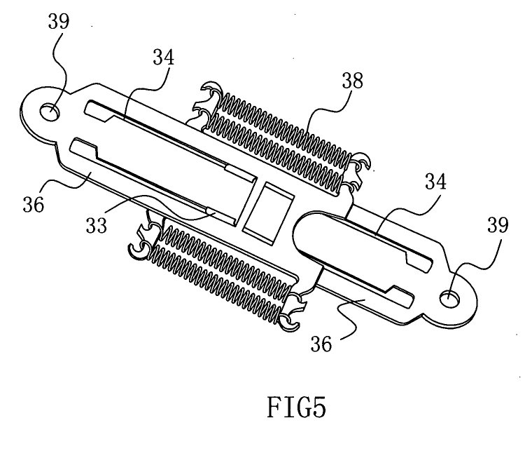

In FIGS. 4 and 5, the stacked interactive flakes 36 include the fulcrum ends, at which the positioning holes 39 are set, and rotating end, two sides of which two spring hangers are respectively set at. As shown in FIG. 4, four extension springs are used for spring 38, whose two ends correspondingly are hung at the spring hangers 35. As shown in FIG. 5, the stacked interactive flakes 36 are inter-engaged up and down and engaged with slot 34 by the matching locking jaw 33, moreover, locking jaw 33 and slot 34 are elastic sliding with mutual space limit.

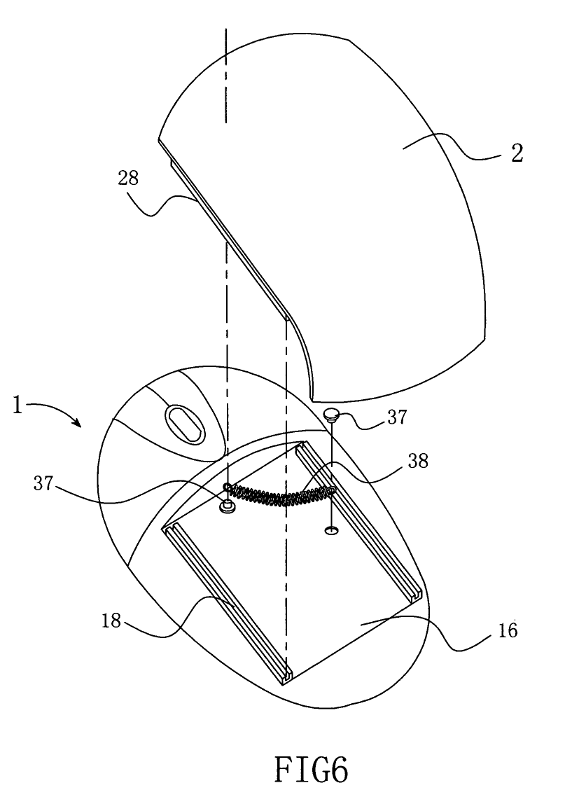

In FIGS. 6, 7 and 8, the upper slide plate is directly placed as the back plate of the hand-rest 2 and the lower slide plate is directly placed as the cover plate 16 of the mouse body 1 correspondingly. Moreover, spring 38 is set up between the base plate of the hand-rest 2 and the cover plate 16 of the mouse body 1. One end of spring 38 is fixed on the cover plate 16 by rivet 39 and the other end is fixed on the back plate of the hand-rest 2. When used, the hand-rest 2 is sliding from one end of the mouse body 1 to the other end; spring 38 is deformed under compression, generating elasticity for resetting to make hand-rest 2 slides to the trend end to achieve the relatively elastic sliding.

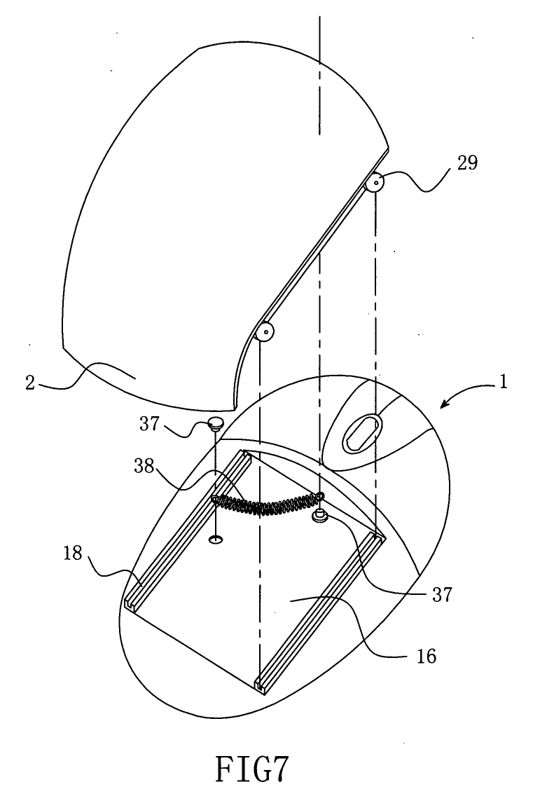

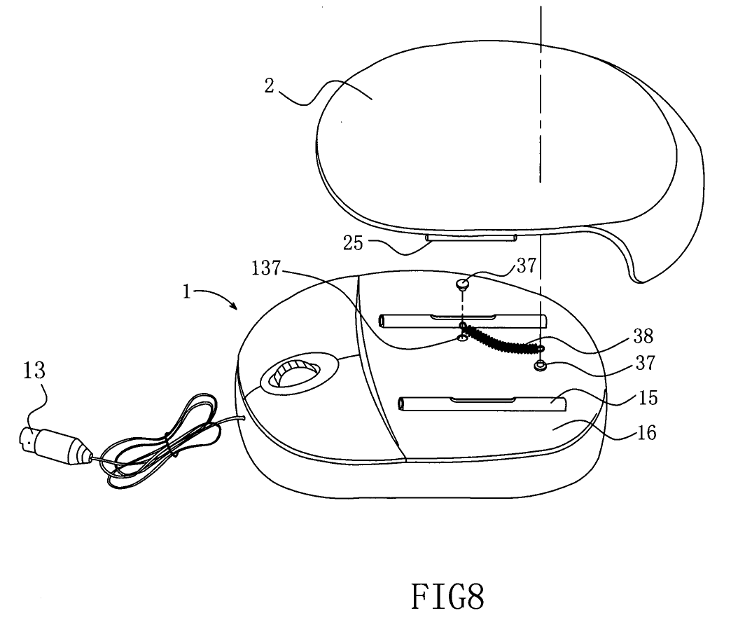

As shown in FIG. 6, guiding slide rail 28 and corresponding guiding linear chute 18 are set on both sides of the back plate of hand-rest 2 and both sides of the corresponding cover plate 16 of mouse body 1. The relative elastic sliding of hand-rest 2 and mouse body 1 is achieved by spring 38. As shown in FIG. 7, roller 29 and corresponding guiding linear chute 18 can also be set on both sides of the back plate of hand-rest 2 and both sides of the corresponding cover plate 16 of mouse body 1. The relative elastic sliding of hand-rest 2 and mouse body 1 is also achieved by spring 38. As shown in FIG. 8, configured guiding pipes can also be set on both sides of the back plate of hand-rest 2 and corresponding cover plate 16 of mouse body 1, with the inner pipe 25 set on both sides of the back plate of hand-rest 2 and the outer pipe 15 set on both sides of the cover plate 16 of mouse body 1. The relative elastic sliding of hand-rest 2 and mouse body 1 is also achieved by spring 38. Thus, the telescopic function of the mouse is achieved.

Of course, during practice, the wired optical mouse is preferred. Both USB plug as shown in FIG. 1, FIG. 2A and FIG. 2B and PS II plug as shown in FIG. 3A, FIG. 3B and FIG. 8 are applicable to it, but it is not limited to wired optical mouse only. The mouse body can also adopt wireless optical mouse as shown in FIG. 6 and FIG. 7 or other mechanical mouse.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A telescopic sliding mouse includes a mouse body, a hand-rest sliding on its back and a slide device which is set between the mouse body and hand-rest, The slide device includes a relatively translational and elastic upper and lower slide plate fixed to the hand-rest and mouse body respectively.

2. The telescopic sliding mouse, as recited in claim 1, wherein pedestal or table board is set under the said hand-rest to fix the said upper slide plates.

3. The telescopic sliding mouse, as recited in claim 2, wherein convex plate for space limit is set on the lower surface of the said pedestal or table board for the location of the said upper slide plate.

4. The telescopic sliding mouse, as recited in claim 3, wherein space-limit opening suiting with the said convex plate for space limit is set at either end of the said upper slide plate.

5. The telescopic sliding mouse, as recited in claim 1, wherein embedding slot or platform is set under the back of the said mouse body to fix the said lower slide plate.

6. The telescopic sliding mouse, as recited in claim 5, wherein convex plate for space limit is set at either end or both ends of the said embedding slot or platform for the location of the stated lower slide plate.

7. The telescopic sliding mouse, as recited in claim 6, wherein space-limit opening suiting with the said convex plate for space limit is set at either end or both ends of the said lower slide plate.

8. The telescopic sliding mouse, as recited in claim 1, wherein both sides of the said upper and lower plates limit each other and cooperate in a linear sliding way, moreover, several fixing holes are respectively set on their plate bodies.

9. The telescopic sliding mouse, as recited in claim 8, wherein two sides of the said upper slide plate are curled downwards as a crimping groove which the linear slide groove goes through.

10. The telescopic sliding mouse, as recited in claim 9, wherein two sides of the said linear slide groove are protruded for space limit at two ends of the said crimping groove.

11. The telescopic sliding mouse, as recited in claim 8, wherein two sides of the said lower slide plate are curled upwards as an outward linear slide rail.

12. The telescopic sliding mouse, as recited in claim 1, wherein the said slide device also contains two stacked interactive flakes rotationally fixed to the upper and lower slide plate respectively, This set of flakes are vertically inter-engaged and symmetrically matched, moreover, there are spring connections between the said stacked interactive flakes, enabling elastic interaction.

13. The telescopic sliding mouse, as recited in claim 12, wherein each of the said stacked interactive flake contains a supporting end and a rotational end, the said supporting ends are set with locating holes and corresponding rivets and fixed to the said upper and low slide plate respectively, besides, spring hangers are set at both sides of the said rotational ends, and both ends of the said springs are hung at the said spring hangers.

14. The telescopic sliding mouse, as recited in claim 13, wherein the said springs are tension springs, distributed symmetrically on both sides of the said staked interactive flakes.

15. The telescopic sliding mouse, as recited in claim 12, wherein corresponding inter-engaged locking jaw and slot are set to the said stacked interactive flakes respectively, and the said locking jaw and slot are matched through sliding and space limit.

16. The telescopic sliding mouse, as recited in claim 1, wherein the said upper slide plate is directly placed as the back plate of hand-rest, while the said lower slide plate is directly placed as the cover plate of mouse body.

17. The telescopic sliding mouse, as recited in claim 16, wherein springs are set between the said back plate of hand-rest and the said cover plate of mouse body, and both ends of the said springs are fixed to the said back and cover plate respectively.

18. The telescopic sliding mouse, as recited in claim 16, wherein guiding slide rail and corresponding guiding linear chute are set on both sides of the said back plate of hand-rest and both sides of the said corresponding cover plate of mouse body.

19. The telescopic sliding mouse, as recited in claim 16, wherein rollers or roll balls and corresponding guiding linear chutes are set on both sides of the said back plate of hand-rest and both sides of the said corresponding cover plate of mouse body.

20. The telescopic sliding mouse, as recited in claim 16, wherein configured guiding pipes are set on both sides of the said back plate of hand-rest and both sides of the said corresponding cover plate of mouse body.
